(19) United States
(12) Patent Application Publication
(10) Pub. No.: US 2025/0224986 A1
(43) Pub. Date: Jul. 10, 2025

(54) SYSTEM AND METHOD FOR CORRELATING SEQUENTIAL INPUT FILE SIZES TO SCALABLE RESOURCE CONSUMPTION

(71) Applicant: Teracloud ApS, Copenhagen K (DK)

(72) Inventors: Daniel Snyder, Belle Mead, NJ (US); John Hogan, Los Angeles, CA (US)

(73) Assignee: Teracloud ApS, Copenhagen K (DK)

(21) Appl. No.: 18/851,507

(22) PCT Filed: Apr. 24, 2023
(86) PCT No.: PCT/EP2023/060705

§ 371 Date: Sep. 26, 2024

Related U.S. Application Data
(60) Provisional application No. 63/334,362, filed on Apr. 25, 2022.

(51) Int. Cl. G06F 9/50; G06F 9/48

(52) U.S. Cl. CPC G06F 9/5016; G06F 9/4881; G06F 2209/486; G06F 2209/5019

(57) ABSTRACT

A system for use in predicting resources required for a program. The system including a processor, a storage device accessible by the processor, and a sequential file prediction program that when executed by the processor configures the system to access a history file to determine sizes of past sequential input files input to a customer program and sizes of resultant past sequential output files produced by the customer program processing the sequential input files, determine a correlation between the sizes of the past sequential input files and the resultant sizes of the past sequential output files, utilize the correlation to predict future sizes of future sequential output files based on the current sizes of current sequential input files, and utilize the predicted future consumption of the scalable resources to perform at least one of memory allocation or to determine scheduling for batch jobs being performed by the system.

### CROSS-REFERENCE TO RELATED APPLICATION

This application claims priority to U.S. Provisional Application No. 63/334,362, filed Apr. 25, 2022, and the contents of which are incorporated herein by reference in their entireties for all purposes.

### TECHNICAL FIELD

The present examples relate to techniques and processes for correlating input file sizes to consumption of scalable resources.

### BACKGROUND

Mainframe computing is a computing platform used today by the largest companies in the world. A mainframe often processes many workloads such as accounts receivable, general ledger, payroll and a variety of applications needed for specific business requirements. These workloads are commonly referred to as jobs.

A mainframe environment includes databases which may be sequential files that can be accessed in any order through indexing. A sequential file is a file generally containing records of the same structure and length. Sequential files are processed sequentially from the start of the file to the end of the file. These sequential files typically reside on a direct access storage device (DASD) or disk drive. Regardless of the storage medium, sequential files are processed by a customer program that performs data manipulation on the record in the sequential files and storing the manipulated record in output files which are typically allocated predefined sizes that may not be optimal for the manipulated record. Conventionally, it is not known how much output file space is required for the output of the program, how long the program will take, or how many resources it will consume.

### SUMMARY

A system for use in predicting resources required for a program. The system comprising a processor, a storage device accessible by the processor, and a sequential file prediction program that when executed by the processor configures the system to access a history file to determine sizes of past sequential input files input to a customer program and sizes of resultant past sequential output files produced by the customer program processing the sequential input files, determine a correlation between the sizes of the past sequential input files and the resultant sizes of the past sequential output files, utilize the correlation to predict future consumption of the scalable resources including future sizes of future sequential output files based on the current sizes of current sequential input files, and utilize the predicted future consumption of the scalable resources to perform at least one of memory allocation or to determine scheduling for batch jobs being performed by the system, wherein the scalable resources include at least one of processing time and memory allocation.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a process for reading and writing input/output files to DASD and Tape and creating and recording system management facility data, according to an embodiment of the disclosure.

FIG. 2 is a block diagram of a process for allocating predefined output file sizes for storing the processed sequential files, according to an embodiment of the disclosure.

FIG. 3 is a block diagram of a process for predicting output file sizes based on input file information, according to an embodiment of the disclosure.

FIG. 4 is a block diagram of a process for predicting output file sizes based on input file information, according to an embodiment of the disclosure.

FIG. 5 is a block diagram of a linear regression process for predicting output file sizes based on input file information for all file combinations, according to an embodiment of the disclosure.

FIG. 6 is a block diagram of a linear regression process for predicting output file sizes based on input file information for a specified file, according to an embodiment of the disclosure.

FIG. 7 is a block diagram of a neural network process for predicting output file sizes based on input file information, according to an embodiment of the disclosure.

FIG. 8 is a block diagram of a process for predicting output file sizes based on input file information in a specific use case, according to an embodiment of the disclosure.

FIG. 9 is a simplified functional block diagram of a computer that may be configured as a server and/or mainframe.

FIG. 10 is a simplified functional block diagram of a personal computer or other work station or terminal device.

### DETAILED DESCRIPTION

### Introduction

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Many software programs, including International Business Machine (IBM)® z/OS programs operate on sequential files and perform collations on the records within these files. A program may take multiple input files and produce multiple output files. The size of the output produced by these programs is conventionally not known before execution, but for practical reasons, the output files cannot grow indefinitely (e.g. their size is defined upon their creation). If the output of a program exceeds the space allocated to the output file, the program will fail and terminate in an error state.

A program (e.g. z/OS program) may fail to complete or may have decreased performance (indicated by increased processing time) if it is limited by some resource. For example, a program may fail to complete if it is limited in output file size or working memory size. If a program is CPU intensive, it may take longer to process when other CPU intensive programs are running. If the operating system knew beforehand what the resource requirements of a program were before executing it, it could allocate sufficient resources (e.g. CPU time, I/O time, memory allocation, etc.) to the job, or re-schedule the execution to minimize load on the system.

A sequential file is a file generally containing records of the same structure and length. Sequential files are processed sequentially from the start of the file to the end. These sequential files typically reside on a direct access storage device (DASD) or disk drive. Regardless of the storage medium, sequential files are typically processed by a customer program by performing data manipulation on the record in the sequential files and storing the manipulated record in output files of predefined sizes.

In an example, a record in a sequential file may contain information about a transactional event, such as credit card transactions, phone calls, purchases of a security to name a few. The customer program (e.g. credit card company program) may process these sequential files by reading the sequential files to collate the records into new records written to output sequential files. Some examples of possible collations include pulling specific transaction details from each record necessary for a particular department (accounting, sales, logistics, etc.) within the credit card company, producing a record summarizing transactions per unique entity, and merging data about each transaction from two different sources (such as matching purchase orders to sell orders).

The customer program is generally designed to execute as part of a batch job which defines a series of steps, each executing the customer program and providing the program references to sequential files via a set of parameters (e.g. “DD statements”) that describe a data set (name, size, etc.) and to specify the input and output resources needed for the data set. A single customer program may perform different functions depending on what parameters are provided. However, the parameters provided to a customer program are unlikely to change for a particular step within a particular job, defined by the job name, step name, and optionally procedure step name. A procedure is a series of steps that can be used across multiple jobs and may have parameters affecting its execution. The names of DD statements are specific to a customer program, and provide a layer of abstraction so the customer program does not need to know the specific name of the sequential file or where it resides. A DD statement may map to an input file or to an output file. The size of the output file is defined upon creation, and if the output is larger than the size of the output file, the customer program may fail to complete. In addition, the size output of the customer program is generally correlated to the processing time (e.g. CPU load, input/output (I/O) time, combination of CPU/IO time, etc.), and working memory required to process the dataset record. Thus, a means for using the DD statement to predict an appropriate output file size for optimal memory allocation (e.g. allocating optimal output file sizes), and for predicting processing resources for determining system timeliness would be beneficial to the customer (e.g. how much memory and processing time is needed for pulling, manipulation and storing transaction details from sequential files).

In an example mainframe environment, a job is a collection of programs, or job steps, instructing a processor to perform particular functions. When a job is represented as a sequence of job control language (JCL) statements, each job step is defined by an EXEC statement referencing a program and supported by DD statements which represent the datasets to be processed. The DD statements may include information such as the dataset name, the dataset volume (e.g. where the dataset is stored) and the dataset size among others. While a job includes one or more programs, or job steps, a single job step may, in turn, represent a procedure, program and/or other process that includes one or more steps, functions, and/or other components that each perform some form of processing. Thus, a job step is a single entry within a job, but is not limited to performing a single step of processing. A job is also often referred to as a batch job, because a collection of JCL is processed in batch by the processor. In this mainframe environment, jobs are continually being processed. These jobs regularly reference datasets (e.g., sequential files) as part of their processing. As such, at any given point in time, some number of jobs may have some number of datasets opened and may be processing data related to those opened datasets.

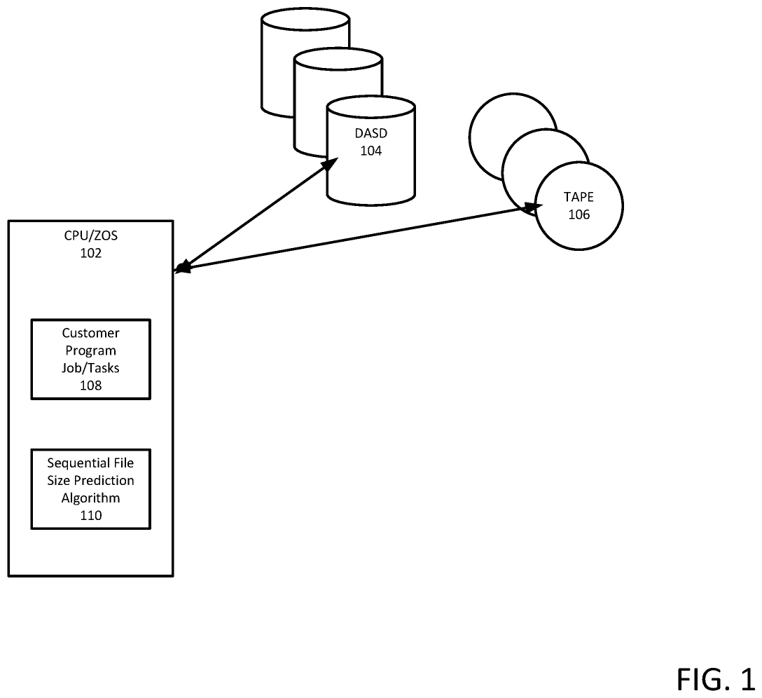

As shown in FIG. 1, the IBM mainframe, also known as the “z platform”, includes CPU/ZOS 102 running the z/OS operating system executes a customer program of jobs/tasks 108 reading and writing (e.g. sequential files) to DASD 104 and Tape 106, and utilizes a USERCATALOG system (not shown) for accounting for data that resides among the multitude of storage devices typically configured to a system. These user catalogs are a component of Data Facility product (DFP), and are an integral component of the Operating System (OS). As part of the operation of the system, jobs and tasks run which create, modify or delete data on the system and the Catalogue records this activity in a catalogue structure for referential integrity. The catalogue itself is an indexed file so that data can be located quickly if it exists in the storage environment. ICF is the acronym that describes this facility. ICF stands for Integrated Catalog Facility. All storage works on the concept that data is contained in a volume, either tape volume or disk volume, also referred to as a DASD, direct access storage device. The distinction between tape and DASD is that DASD storage is online to the system, whereas tape data is more commonly offline and brought online when it is requested by a process or task. A DASD volume can contain multitudes of sequential files also known as Datasets. Multiple tasks can access disk sequential file datasets on the same volume concurrently as there are usually multiple paths to get to the data on the same DASD volume. Tapes, on the other hand, are dedicated to being allocated to a single task at a time. Tape data can stack multiple datasets on a volume like DASD. However only 1 task can access 1 single dataset on a Tape volume at a time. Tape data is processed in a linear or sequential fashion. The primary relevant information for any dataset is the name of the dataset, the volume(s) to which the data resides, and in the case of Tape data, where in the linear tape, file sequence the data resides. Regardless of the storage means, a customer program performs the jobs/tasks on the sequential input files and produces sequential output files. In addition, the z/OS operating system executes a sequential file prediction algorithm 110 which predicts output file sizes and other consumable resources based on input file sizes. Sequential file prediction algorithm 110 is described in more detail below. The sequential file prediction algorithm 110 is differentiated from the customer program in that the customer program is any program in which a failure may be prevented, or performance of may be improved, based upon the predictions made by the sequential file prediction algorithm 110. The sequential file prediction algorithm 110 may be encoded in a sequential file prediction program. It is contemplated that the sequential file prediction algorithm 110 may behave in a partially or fully recursive manner.

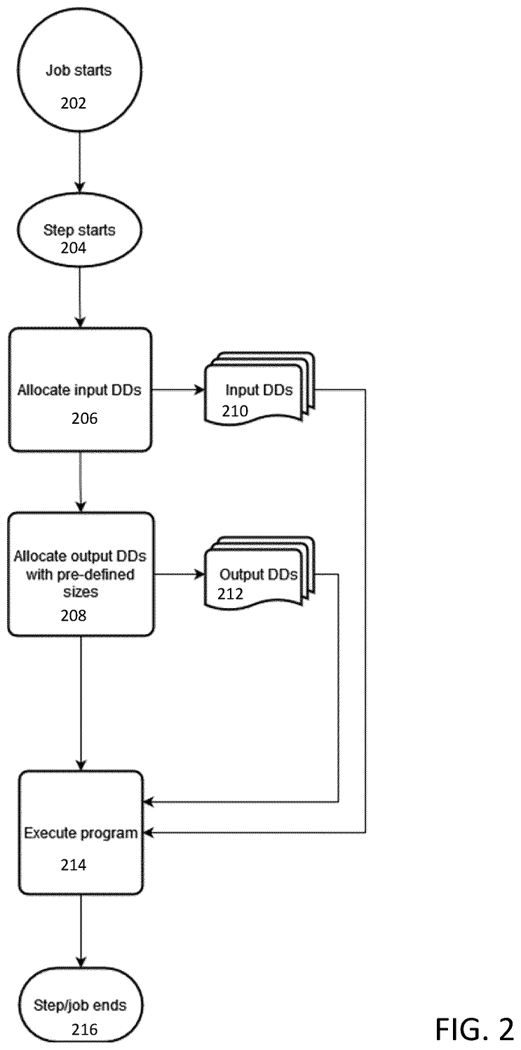

FIG. 2 is a block diagram of a conventional example of a process for allocating predefined output file sizes. In steps 202 and 204, the job and step starts to execute for processing sequential files. In step 206, the system allocates input file DDs 210 which identify input files for processing. In step 208, the system also allocates output file DDs 212 with predefined sizes for storing the processed information. In step 214, the customer program processes the input files indicated by the input file DDs and stores the result in output files indicated by the output file DDs and the step/job ends in step 216.

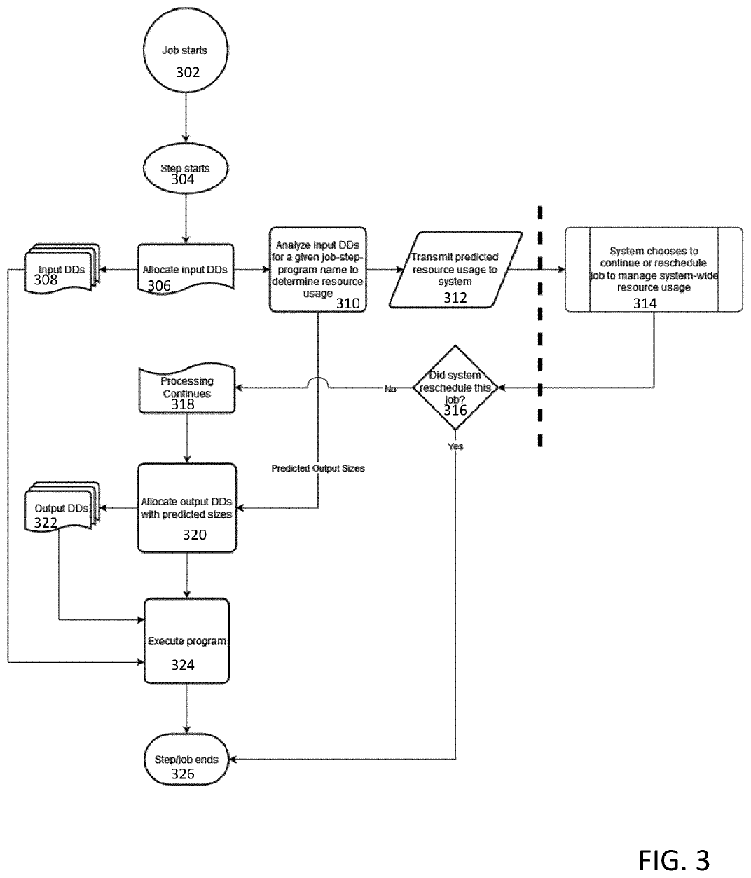

Rather than allocating output file DDs of a predefined size that may or may not be optimal for storage of the customer program output, prediction of the output file sizes would be beneficial. FIG. 3 is a block diagram of an example of a process for predicting output file sizes based on input file information in the input file DDs. Similar to FIG. 2, in steps 302 and 304, the job and step starts to execute for processing sequential files. In step 306, the system allocates input file DDs 308 for processing. However, rather than allocating output file DDs with predefined sizes, step 310 analyzes information (DDname, DDsize, etc.) from the input file DDs and predicts optimal sizes for one or more output files for storing the processed information and allocates the output file DDs accordingly in steps 320 and 322. In step 324, the customer program processes the input files indicated by the input file DDs and stores the result in output files indicated by the output file DDs and the step/job ends in step 326. In addition, at step 312, the system transmits the predicted resource usage to the operating system (e.g. z/OS) which allows the operating system to perform an action such as choosing to continue jobs as is, or to reschedule jobs to manage the system-wide resources in step 314. If it is determined in step 316 that the system rescheduled jobs, the step/job ends in step 326. However, if it is determined in step 316 that the system has not rescheduled jobs, processing continues in step 318.

Rather than executing a job at a pre-determined time when the current load on the system may be high, prediction of the processing resources necessary to execute a job, and rescheduling the job for a later time when system load is lower would be beneficial. If a job is initiated and it is predicted to use a large amount of working memory while available working memory on the system is low, the operating system may choose to schedule the job for a later time when more working memory is available for the job.

The analysis of the input file DD information for predicting the optimal sizes for the one or more output files, and predicting the consumption of other scalable resources (e.g. DDname, CPU time, I/O time, memory allocation, etc.) can be performed by a number of different methods. These methods including linear regression techniques and neural network techniques, among others, that determine a predictive function based on historical file data indicating known relationships between past input file sizes and their corresponding resource requirements. These prediction techniques are described below.

### Predictive Solution Generally

A goal of the predictive solution is to analyze historical data of job executions to create a predictive model, computing the quantity of one or more scalable resources required by a customer program, given the size of input DDs. Some examples of a scalable resource include CPU time, real world time, the size of an output DD, and amount of working memory used. Historical data of all jobs are kept in SMF records. From these SMF records, the system can extract the job name, procedure name, step name, customer program name, a list of input and output DDs and their sizes, CPU time, run time, number of I/O operations, and more.

The job, procedure, step, and customer program names are used as an identifier to build a predictive model. A model may not be tied to a customer program name alone, as it may perform different operations depending on the parameters, and these parameters may not be accessible from the SMF records. However, the parameters provided to a customer program are unlikely to change within one specific job, so the behavior of a customer program is likely to remain consistent from one job execution to the next.

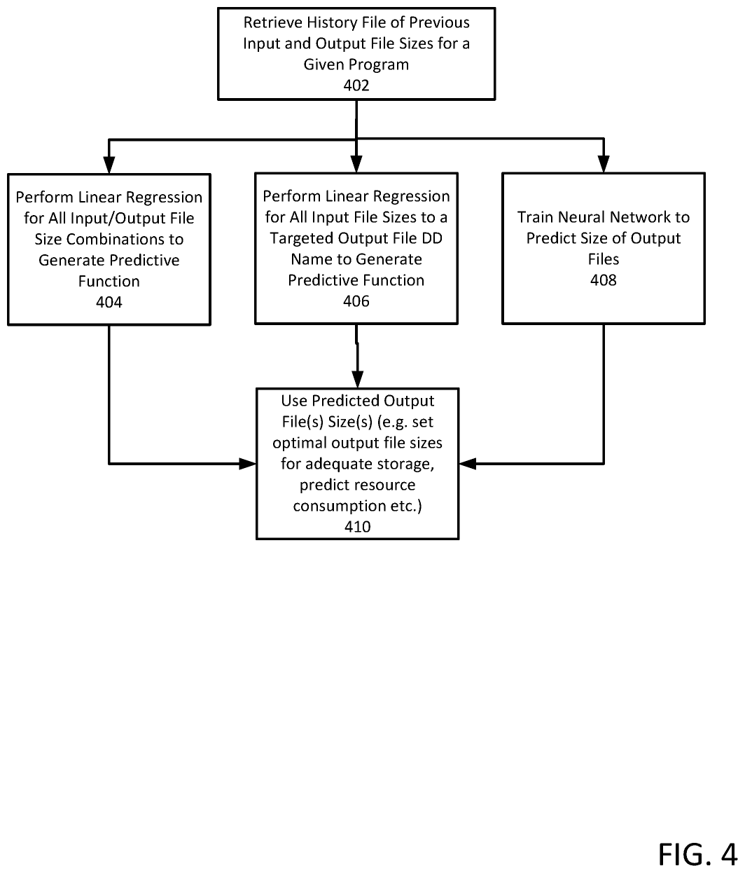

FIG. 4 is a block diagram of an overall solution for predicting output file sizes and processing resources required based on input file information. Specifically, in step 402, the system retrieves a history file showing known past input file sizes, past resource consumption, and their resultant past output file sizes for previous jobs executing the customer program. The idea being that the sizes of the input files and resultant resource consumption have a correlation that can be determined and then used for future predictions. The customer program may use multiple input and output files which adds another level of complexity in learning the relationship (e.g. correlation) of input file sizes to output file sizes. As with any other data set, the more observations in the data set, the greater the accuracy of the conclusion (e.g. the more relationships that are analyzed results in a more accurate determination of the correlation).

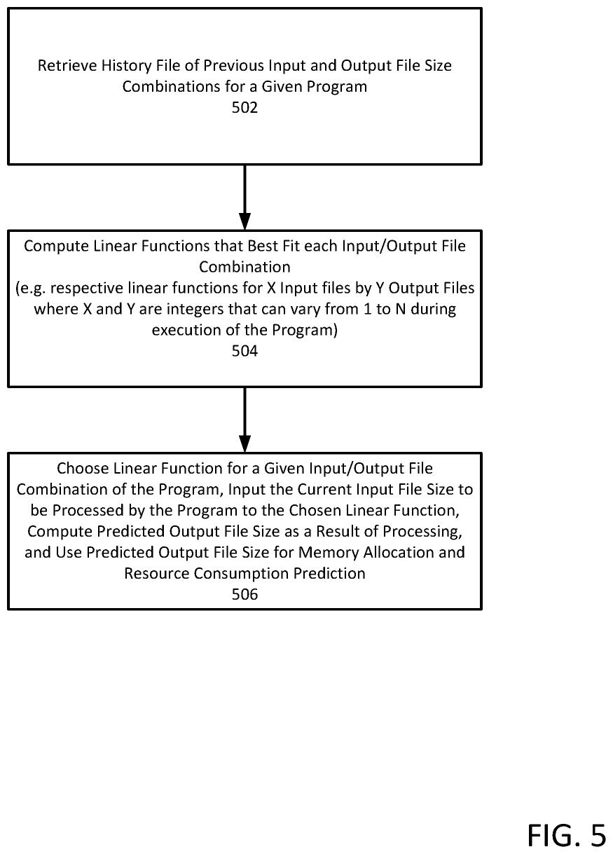

More specifically, the system uses this historical data to train one of the prediction algorithms in steps 404-408 which could include linear regression for all input/output file sizes, linear regression for a targeted resource (e.g. the size of a specific output DD, or IO time), and a neural network, which may predict all resources used in one algorithm. Once the linear function or neural network is trained, the system may then use the prediction algorithm in step 410 to accurately predict future resource consumption based on future input file sizes to be processed by the customer program. Developing/Training the linear equation and neural network for resource consumption prediction is described in more detail in FIGS. 5-8.

### Linear Regression Solution

FIG. 5 is a block diagram of an example of a linear regression process for predicting resource consumption based on input file information and the presented combination of input and output DD statements for all possible DD combinations. In step 502, the system retrieves a history file showing a relationship between input file sizes and their resultant consumption of resources for previous jobs performed by the customer program. In step 504, the system computes a linear function that best fits the input file sizes to resource usage retrieved from the history file.

For example, a linear regression could be performed using the input file size as an explanatory variable and the output file size as the predictor variable. If the hypothesis holds true for the program step in the historical file, then a correlation between input and output file sizes can be established so that the output size can be predicted for future files. In one example, the customer program may reduce/increase the output file size so a variable of percent change between input and output may also be computed and recorded. In another example, the customer program splits and merges records, and has multiple inputs and outputs. This type of customer program may need multiple passes through the previously stated linear regression.

The results of step 504 in FIG. 5 would be a linear function that predicts output file sizes for all possible combinations of input files vs output files. For example, if the customer program can process up to X input files and produce up to Y output files, a linear regress would be separately performed for each combination (e.g. X times Y linear regressions). Once the linear regressions are computed, the system, in step 506, can then choose a linear function given a future input/output file combination. For example, if a future job utilizes includes 2 input files and 4 output files, the linear function for the 2×4 scenario is chosen and used to predict the output file sizes and other resource consumption.

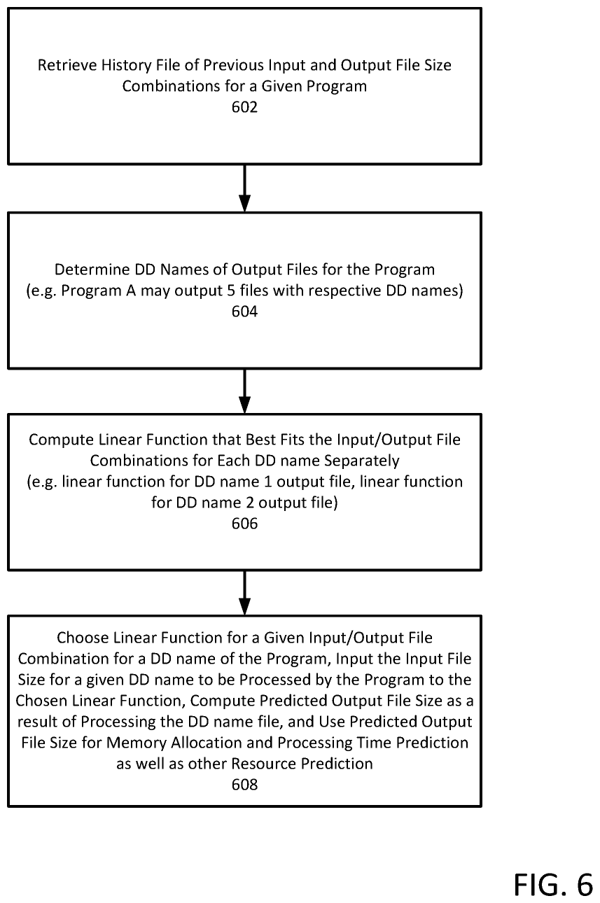

Rather than producing linear functions for all possible numbers of input files versus all possible numbers of output files, the system could perform linear regression of all input file sizes for a particular consumable, scalable resource (e.g. specific DDname or working memory). FIG. 6 is a block diagram of an example of a linear regression process for predicting output file sizes based on input file information for a specified file DDname. In step 602, the system retrieves a history file showing a relationship between input file sizes and resultant output file sizes for previous jobs performed by the customer program. In step 604, the system determines possible DDnames to be proceed by the customer program. For example, customer program A may be designed to output one of five files with respective DDnames. Then, in step 606, the system computes a linear function that best fits the Input/Output file combinations for each DDname separately. For example, a linear function for DDname 1 output file is computed, while another linear function for DDname 2 output file is computed. In step 608, the system can then choose a linear function for a given input/output file combination for a DD name of the customer program, input the input file size for a given DD name to be processed by the customer program to the chosen linear function, compute predicted output file sizes and consumption of other resources as a result of processing the DD name file, and use the predicted output file size for memory allocation and processing time prediction as well as rescheduling of jobs/steps if beneficial.

For the linear regression there may be more than N factors for N input DDs. For example, for each input DD, X, k transformations can be applied to it (e.g. X², X³, log(X), sqrt (X), etc.) which are then input into the linear equation. As a result, the total number of inputs would be k*N, k being the number of transformations applied to each input DD. The linear equation would then output the true size for one output DD.

Regardless, if there is a linear relationship between the size of inputs and a consumable resource, a linear equation can be constructed that multiplies the size of every input DD (sₙ) by some weight (wₙ) and sums the values together to get the quantity of a desired resource:

$${w}_{1} * {s}_{1} + {w}_{2} * {s}_{2} + ⋯ + {w}_{n} * {s}_{n} + c = r$$

If a non-linear relationship exists between the size of inputs and a consumable resource, a set of transformation functions (ƒₖ) can be applied to each input size to produce a set of inputs. Each input DD could also be passed through a transformation function ƒ (such as squaring, cubing, or taking the logarithm) and provided as another input to open the possibility of non-linear relationships. If there are k transformations applied to 12 input DDs:

$${w}_{1} {f}_{1} ( {s}_{1} ) + {w}_{2} {f}_{2} ( {s}_{1} ) + ⋯ + {w}_{k} {f}_{k} ( {s}_{1} ) + {w}_{k + 1} {f}_{1} ( {s}_{2} ) + ⋯ + {w}_{nk - 1} {f}_{k - 1} ( {s}_{n} ) + {w}_{nk} {f}_{k} ( {s}_{n} ) = r$$

The transformations applied can be summarized as follows:

$$F ( \begin{matrix}{s}_{1} \\ {s}_{2} \\ ⋮ \\ {s}_{n}\end{matrix} ) = [ \begin{matrix}{f}_{1} ( {s}_{1} ) \\ {f}_{2} ( {s}_{1} ) \\ ⋮ \\ {f}_{k} ( {s}_{1} ) \\ {f}_{1} ( {s}_{2} ) \\ ⋮ \\ {f}_{k} ( {s}_{n} )\end{matrix} ]$$

The weights are specific to one resource, and other resources will have a different set of weights used. Once a set of weights has been determined for every desired resource, the system can calculate prediction resource usage given a list of input sizes. Assuming there are n input DDs and m output DDs, the sizes of output DDs can be predicted using the following operation:

$$W * F ( \vec{s} ) = \vec{r}$$

$$[ \begin{matrix}{w}_{1 , 1} & {w}_{1 , 2} & ⋯ & {w}_{1 , n} \\ {w}_{2 , 1} & {w}_{2 , 2} & ⋯ & {w}_{2 , n} \\ ⋮ & ⋮ & ⋱ & ⋮ \\ {w}_{m , 1} & {w}_{m , 2} & ⋯ & {w}_{m , n}\end{matrix} ] * [ \begin{matrix}{F ( s )}_{1} \\ {F ( s )}_{2} \\ ⋮ \\ {F ( s )}_{n}\end{matrix} ] = [ \begin{matrix}{r}_{1} \\ {r}_{2} \\ ⋮ \\ {r}_{m}\end{matrix} ]$$

A biasing constant can also be added to the equation by including another column of weights and adding the value 1 to the end of the input size vector [symbol] .

The weights of this equation can be computed by analyzing the historical file data from the SMF record. By looking at the sizes of input and output DDs for each run of a customer program, optimal weights that best predict the output DD sizes can be computed.

Only one linear regression is required per output DD per customer program. Finding the right combination of weights (wₙ) will result in a function that can compute an output size given a list of input sizes. If there are n unique input DDs across k runs of a particular customer program, the system can construct this set of linear equations for each output DD:

$$\begin{matrix}{w}_{1} * {s}_{11} + {w}_{2} * {s}_{12} & + ⋯ + & {w}_{n} * {s}_{1 n} + c = {r}_{1} \\ {w}_{1} * {s}_{21} + {w}_{2} * {s}_{22} & + ⋯ + & {w}_{n} * {s}_{2 n} + c = {r}_{2} \\ ⋮ & ⋯ & ⋮ \\ {w}_{1} * {s}_{k 1} + {w}_{2} * {s}_{k 2} & + ⋯ + & {w}_{n} * {s}_{kn} + c = {r}_{k}\end{matrix}$$

Which can be written as:

$$S * \vec{w} = \vec{r}$$

$$[ \begin{matrix}{s}_{1 , 1} & {s}_{1 , 2} & ⋯ & {s}_{1 , n} \\ {s}_{2 , 1} & {s}_{2 , 2} & ⋯ & {s}_{2 , n} \\ ⋮ & ⋮ & ⋱ & ⋮ \\ {s}_{k , 1} & {s}_{k , 2} & ⋯ & {s}_{k , n}\end{matrix} ] * [ \begin{matrix}{w}_{1} \\ {w}_{2} \\ ⋮ \\ {w}_{n}\end{matrix} ] = [ \begin{matrix}{r}_{1} \\ {r}_{2} \\ ⋮ \\ {r}_{k}\end{matrix} ]$$

k denotes the index of a historical execution of a customer program and is used to avoid confusion with m used above, which denotes the index of a unique output DD. The system can solve for [symbol] using the following equation:

$$\begin{matrix}{S}^{+} = {( {S}^{T} * S )}^{- 1} * {S}^{T} \\ \vec{w} = {S}^{+} * \vec{r}\end{matrix}$$

This will result in the smallest difference of squares between S* [symbol] and [symbol] . While computing S⁺ will be computationally expensive, it only needs to be computed once per customer program. Then for each output DD of that customer program, the vector of all its historical sizes can be multiplied by S⁺ to get the weights vector. Once all [symbol] vectors have been solved, the row vectors can be multiplied by a vector of known input sizes to predict the sizes of all output DDs.

Another approach to solving for [symbol] is using gradient descent.

$$S * \vec{w} = \vec{r}$$

$$[ \begin{matrix}{s}_{1 , 1} & {s}_{1 , 2} & ⋯ & {s}_{1 , n} \\ {s}_{2 , 1} & {s}_{2 , 2} & ⋯ & {s}_{2 , n} \\ ⋮ & ⋮ & ⋱ & ⋮ \\ {s}_{k , 1} & {s}_{k , 2} & ⋯ & {s}_{k , n}\end{matrix} ] * [ \begin{matrix}{w}_{1} \\ {w}_{2} \\ ⋮ \\ {w}_{n}\end{matrix} ] = [ \begin{matrix}{r}_{1} \\ {r}_{2} \\ ⋮ \\ {r}_{k}\end{matrix} ]$$

Gradient descent is an iterative process, where the partial derivative of a cost function C is taken in terms of each weight in order to create a gradient. This gradient is then used to adjust all weights in order to step towards a minimum in the cost function:

$$\vec{{w}_{t + 1}} = \vec{{w}_{t}} - α ∇ C ( \vec{{w}_{t}} )$$

$$∇ C ( \vec{{w}_{t}} ) = \frac{1}{k} {\sum }_{i = 0}^{k} ∇ {C}_{i} ( \vec{{w}_{t}} )$$

$$∇ {C}_{i} ( \vec{{w}_{t}} ) = [ \begin{matrix}\frac{\partial {C}_{i}}{\partial {w}_{t , 0}} ( \vec{{w}_{t}} ) \\ \frac{\partial {C}_{i}}{\partial {w}_{t , 1}} ( \vec{{w}_{t}} ) \\ ⋮ \\ \frac{\partial {C}_{i}}{\partial {w}_{t , n}} ( \vec{{w}_{t}} )\end{matrix} ]$$

Where α is the “learning rate”, [symbol] denotes the weight vector at a particular iteration of training, w_{t,n} denotes a value within a weight vector, and Cᵢ denotes the cost function associated with a particular training observation out of k observations.

A gradient vector, like a derivative, describes the rate of change. This vector describes the direction and rate of fastest increase. By subtracting the gradient from the weights, the weight vector moves in the direction of fastest decrease in order to move towards a minimum. This is done iteratively, taking small steps down the gradient and re-evaluating at the next point in order to prevent overshooting a minimum.

### Neural Network Solution

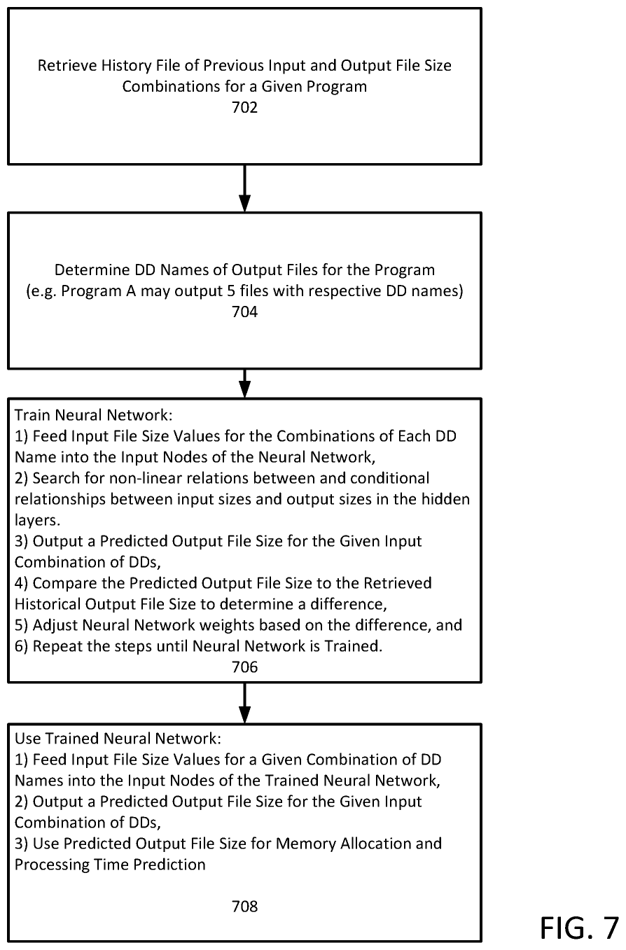

FIG. 7 is a block diagram of an example of another solution that uses a neural network process for predicting output file sizes based on input file information. In step 702, the system retrieves a history file showing a relationship between input file sizes and resultant output file sizes for previous jobs performed by the customer program. In step 704, the system determines DDnames and output files for the customer program. For example, customer program A may output five files with respective DDnames. Then, in step 706, the system Trains a Neural Network by the following steps: 1) feed input file size values for the combinations of each dd name into the input nodes of the neural network, 2) search for non-linear relations between and conditional relationships between input sizes and output sizes in the hidden layers, 3) output a predicted output file size for the given input combination of DDs, 4) compare the predicted output file size to the retrieved historical output file size to determine a difference, 5) adjust neural network weights based on the difference, and 6) repeat the steps until neural network is trained. Then in step 708, the system can use the trained neural network to: 1) feed input file size values for a given combination of DD names into the input nodes of the trained neural network, 2) output a predicted output file size for the given input combination of DDs, and 3) use predicted output file size for memory allocation and processing time prediction as well as rescheduling of jobs/steps if beneficial.

A single neural network can be made to predict the size of all output DDs at once. This neural network would be constructed to have one input layer (one set) of input nodes, one output layer of output nodes, and multiple layers of nodes in between the input and output. In each layer, each node receives input from all nodes in the previous layer and computes a set of linear equations on these inputs. The resulting value is then passed to each node in the next layer for it to compute its own set of linear equations. Very complex relationships can be modeled, and external variables such as parameters or flags passed to the customer program can also be encoded as input to the network, which it can then account for.

The input to this algorithm can take many forms. For example: a) each input node may receive the real size of one input DD, b) the size of one input DD may be split across multiples input nodes, c) each input node may be a binary digit of the size of an input DD, each input node may be a binary digit relating to an order of magnitude of the size, and each input node may be normalized size of an input DD (scaled to be between 0 and 1). The input and output data will then be manipulated to convert between real sizes and data the algorithm uses during processing.

Gradient descent can also be used to train the algorithm as mentioned in the previous proposal to find the right weights and biases for each node. By providing the algorithm with the historical data, a cost function can be evaluated for each data point to grade how close the algorithm is to the desired result. By evaluating the cost function over many historical data points, a gradient can be computed to determine what weights and biases need to change in the network to minimize the cost function. Since the gradient may change over the vector space of all weights and biases, a small step is taken down the gradient, and the process is repeated many times.

There are several advantages to using a neural network. They can model more complex relationships between the inputs and outputs, one model can solve for all input and output DDs of a particular customer program, and parameters that influence output size can be encoded as input to the network which it can then account for. Some parameters may include, input file sizes, logical record length and block size of input files, record format, day of week/year of job execution, parameters passed to the customer program, encoded as on-off flags or as an enumerated value, names of DDs, which could be encoded as an index, duration of job execution.

Some options for a neural network include: a) a network with no data normalization of any kind. In this case, each input and output node would be equal to the unbounded size of the corresponding input/output DD. This is essentially a multi-leveled linear equation solver, where each layer of the network is a set of linear equations exactly like the first example, b) sizes of each input and output DD would be encoded into binary, with each input/output node of the network corresponding to one specific bit of the size of one specific input or output DD, c) normalizing input data using logarithms or z score normalization of the values and possibly passing the resulting values through normalization functions such as sigmoid or tanh. Using logs will dramatically reduce the range of input sizes while maintaining a meaningful difference between extremely large or extremely small data sets. Using a typical normalization function (such as sigmoid) without logarithms would result in negligible differences between values at the extreme, even if they vary by a large quantity, d) each input and output node correspond to a specific order of magnitude. This is a generalization between the two above methods. This has an advantage in that the system can create buckets to put each DD into based on their size, and instead of requiring 40 bits (nodes) just to describe a single 1 TB DD, the system can encode it into 10 bits or even fewer. Using this approach may provide a better distinction between the sizes of inputs resulting in a more accurate model.

Once data normalization is done, operation of the network is essentially the same. A neural network is conceptually split up into layers, with each layer being comprised of a set of nodes. There is one input layer, one output layer, and several middle or “hidden” layers. Starting with the first middle layer, each node in a layer receives input from every node in the previous layer. Each node has a set of weights ( [symbol] ) it multiplies the values ( [symbol] ) by and adds a bias b:

$$\vec{w} * \vec{{x}_{0}} + b = {x}_{1}$$

If there are m nodes in the previous layer, and n nodes in the current layer, a layer can be processed using the following operation:

$${x}_{1 , n} = σ ( {\sum }_{i = 0}^{m} {w}_{i} {x}_{0 , i} + {b}_{n} )$$

$$σ ( [ \begin{matrix}{w}_{1 , 1} & {w}_{1 , 2} & ⋯ & {w}_{1 , m} \\ {w}_{2 , 1} & {w}_{2 , 2} & ⋯ & {w}_{2 , m} \\ ⋮ & ⋮ & ⋱ & ⋮ \\ {w}_{n , 1} & {w}_{n , 2} & ⋯ & {w}_{n , m}\end{matrix} ] * [ \begin{matrix}{x}_{0 , 1} \\ {x}_{0 , 2} \\ ⋮ \\ {x}_{0 , m}\end{matrix} ] = [ \begin{matrix}{b}_{1} \\ {b}_{2} \\ ⋮ \\ {b}_{n}\end{matrix} ] ) = [ \begin{matrix}{x}_{1 , 1} \\ {x}_{1 , 2} \\ ⋮ \\ {x}_{1 , n}\end{matrix} ]$$

The top equation is the function of each node in the network, while the bottom equation is an equation to compute one layer of the network. σ is an activation function which helps to limit the range of the output. The subscripts x₀ and x₁ serve to differentiate between the output of the previous layer, and the output of the current layer. The output of each layer is provided as input to the next, possibly passing through some sort of activation function which serves to limit the range of outputs of the node. Activation functions help to prevent values from growing too large and either becoming meaningless to the network or overflowing the limits of the data type size.

Stochastic gradient descent is used to train a neural network by gradually approximating the optimal weights and biases to model the relationship between input and output. By combining all weights and biases from all layers into one vector, a gradient of the cost function can be computed in terms of all weights and biases. Note that the partial derivative of the cost function will be different from layer to layer, as layers downstream will change the impact a particular weight or bias has on the cost function.

Once the linear functions are computed, the system chooses a linear function for a given input/output file combination for a DD name of the customer program, inputs the input file size for a given DD name to be processed by the customer program to the chosen linear function, computes predicted output file size as a result of processing the DD name file, and uses predicted output file size for memory allocation and processing time prediction.

### Use Case

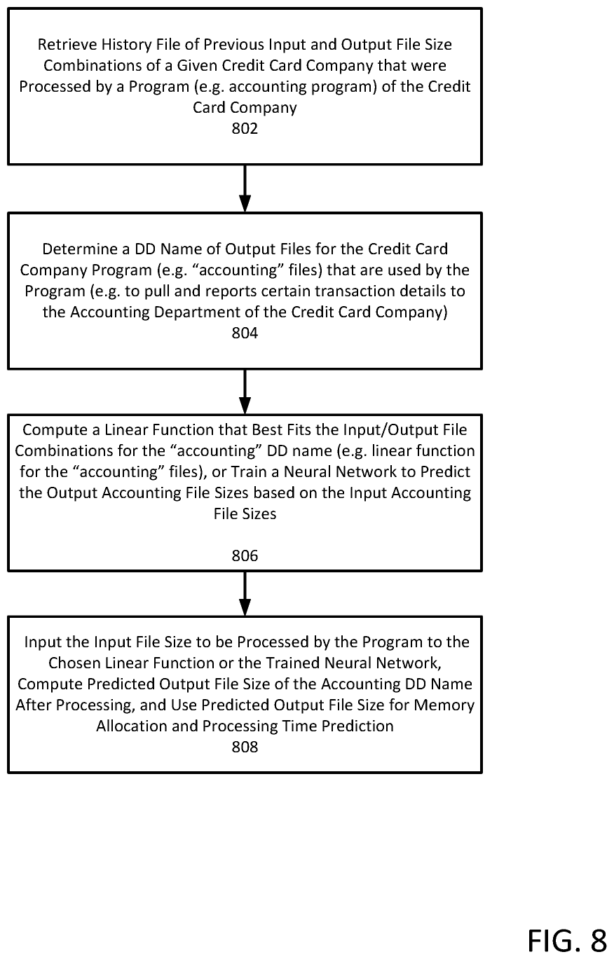

FIG. 8 is a block diagram of an example of a process for predicting output file sizes based on input file information in a specific use case of a credit card company. In step 802, the system retrieves the history file of previous input and output file size combinations that were previously processed by a customer program (e.g. accounting program) of the credit card company. In step 804, the system determines a targeted DD name of output files for the credit card company program (e.g. “accounting” files) that are used by the customer program (e.g. program to pull and report certain transaction details to the accounting department of the credit card company). In step 806, the system computes a linear function that best fits the input/output file combinations for the “accounting” DD name (e.g. linear function for the “accounting” files), or train a neural network to predict the output accounting file sizes based on the input accounting file sizes. Then, in step 808, the system inputs the input file size to be processed by the customer program to the chosen linear function or the trained neural network, computes predicted output file size(s) of the accounting DD name after processing, and uses the predicted output file size for memory allocation and processing time prediction of Jobs as well as rescheduling of jobs/steps if beneficial. In one example, the system may allocate memory for storing the output files based on the predicted output file sizes. In another example, the system may predict processing time of the input files to produce the output files. As mentioned above, this processing time can be used to modify/schedule jobs, etc.

### System Hardware

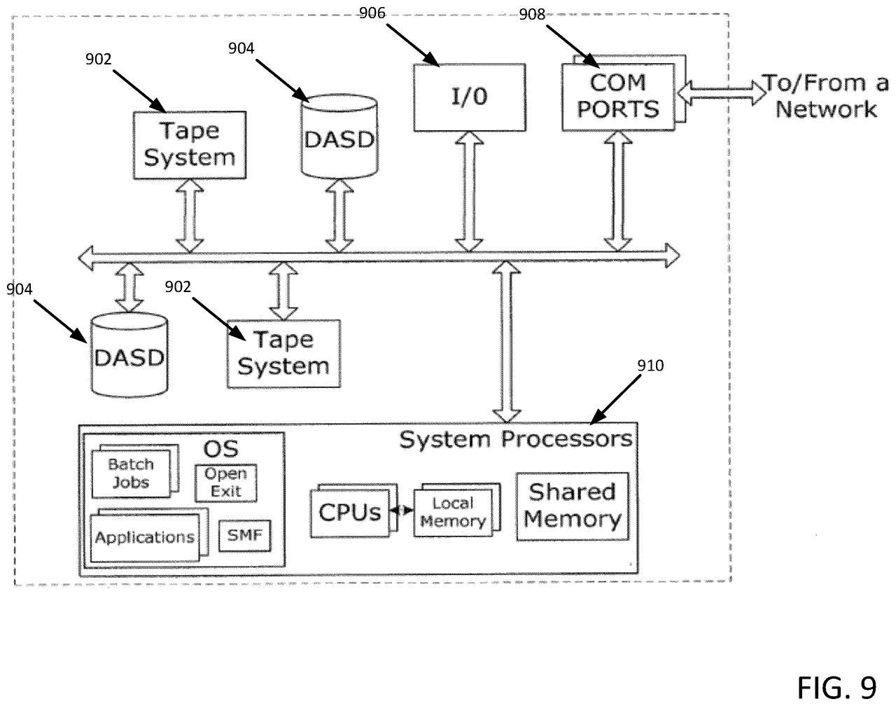

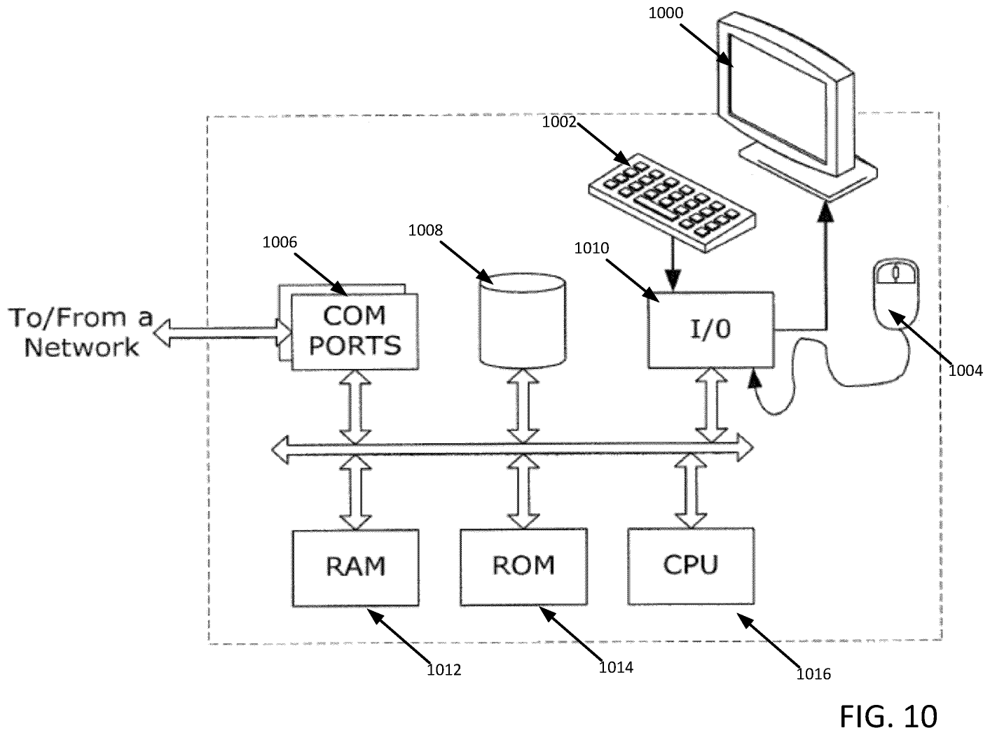

FIGS. 9 and 10 provide functional block diagram illustrations computer hardware platforms. FIG. 9 illustrates a network or host computer platform, as may typically be used to implement a server and/or mainframe including but not limited to tape systems 902, DASDs 904, user input/output 906, communication ports 908 and system processors 910 including CPUs, memory, an operating system, applications, batch jobs, SMF and the like. FIG. 10 depicts a computer with user interface elements, as may be used to implement a personal computer or other type of work station or terminal device, although the computer of FIG. 10 may also act as a server if appropriately programmed. In this example, the computer in FIG. 10 includes monitor 1000, keyboard 1002, mouse 1004, communication ports 1006, database 1008, user I/O 1010, RAM 1012, ROM 1014, CPU 1016 and the like. It is believed that the structure and general operation of such equipment as shown in FIGS. 9 and 10 should be self-explanatory from the high-level illustrations.

It is noted that a mainframe, for example, includes a data communication interface for packet data communication and an input/output (I/O) controller. The I/O controller manages communication to various I/O elements and storage facilities. Storage facilities include one or more direct access storage devices (DASD) and/or one or more tape systems. Such storage facilities provide storage for data, jobs for managing batch processing and applications. The mainframe includes an internal communication bus providing a channel of communication between the communications ports, the I/O controller, and one or more system processors. Each system processor includes one or more central processing units (CPUs) and local memory corresponding to each CPU, as well as shared memory available to any CPU. An operating system (OS) executed by the system processors manages the various jobs and applications currently running to perform appropriate processing. The OS also provides a system management facility (SMF) and open exit points for managing the operation of the mainframe and the various jobs and applications currently running. The hardware elements, operating systems, jobs and applications of such mainframes may be conventional in nature. Of course, the mainframe functions may be implemented in a distributed fashion on a number of similar platforms, to distribute the processing load, and/or replicated across one or more similar platforms, to provide redundancy for the processing. As such, FIG. 9 also depicts a replicated environment. Although details of the replicated environment are not depicted, such replicated environment typically contains similar components as already described in relation to the primary mainframe of FIG. 9.

It is also noted that a computer type user terminal device, such as a PC, similarly includes a data communication interface CPU, main memory and one or more mass storage devices for storing user data and the various executable programs. The various types of user terminal devices will also include various user input and output elements. A computer, for example, may include a keyboard and a cursor control/selection device such as a mouse, trackball, or touchpad; and a display for visual outputs. The hardware elements, operating systems and programming languages of such user terminal devices may be conventional in nature.

Hence, aspects of the methods for recording the time each step within a job executing within a mainframe computing environment begins and ends outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through a global information network (e.g. the Internet®) or various other telecommunication networks. Such communications, for example, may enable loading of the software from one computer or processor into another, for example, from a management server or host computer into the mainframe platform that will execute the various jobs. Thus, another type of media that may bear the software elements includes optical, electrical and electromagnetic waves, such as used across physical interfaces between local devices, through wired and optical landline networks and over various air-links. As used herein, unless restricted to non-transitory, tangible “storage” media, terms such as computer or machine “readable medium” refer to any medium that participates in providing instructions to a processor for execution.

Non-volatile storage media include, for example, optical or magnetic disks, such as any of the storage devices in any computer(s) or the like, such as may be used to hold datasets of sequential files and customer/prediction programs for enterprise applications. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge or any other medium from which a computer can read programming code and/or data. Many of these forms of computer readable media may be involved in carrying one or more sequences of one or more instructions to a processor for execution.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A system for use in predicting resources required for a program, the system comprising:
a processor;
a storage device accessible by the processor;
one or more sequential input files stored in the storage device, each consisting of a dataset comprising one or more records;
a customer program configured to read and perform data manipulation on the one or more records in the one or more sequential input files in accordance with a job that references the one or more sequential input files and to write one or more corresponding manipulated records into one or more corresponding sequential output files on the storage device; and
a sequential file prediction program that when executed by the processor configures the system to:
access a history file to determine sizes of past sequential input files of the one or more sequential input files input to the customer program and sizes of resultant past sequential output files produced by the customer program processing the sequential input files,
determine a correlation between the sizes of the past sequential input files and the resultant sizes of the past sequential output files,
utilize the correlation to predict future consumption of the scalable resources including future sizes of future sequential output files based on the current sizes of current sequential input files, and
utilize the predicted future consumption of the scalable resources to perform at least one of memory allocation or to determine scheduling for batch jobs to be performed by the system,
wherein the scalable resources include at least one of processing time, working memory or input/output time.

2. The system of claim 1, wherein the processor is further configured to determine the correlation by performing a linear regression on the sizes of the past sequential input files and the resultant consumption of scalable resources, the linear regression producing a linear function for performing the prediction of the future consumption of the scalable resources based on the current sizes of current sequential input files of the one or more sequential input files.

3. The system of claim 2, wherein the processor is further configured to perform the linear regression as N×M linear regressions for N×M combinations of N input files by M output files, where N and M are integer values ranging between 1 and a maximum number of input files and output files that is supported by the program.

4. The system of claim 2, wherein the processor is further configured to perform the linear regression K×N linear regressions for N input files and K transformations for each of the scalable resources consumed, where N is an integer value ranging from 1 to a number of indicating each input file data definition (DD).

5. The system of claim 1, wherein the processor is further configured to determine the correlation by training a neural network by inputting the sizes of the past sequential input files, processing the sizes of the past sequential input files based on set weights, predicting resource consumption of the scalable resources, computing a difference between the predicted resource consumption and the known resultant consumption of past scalable resources, and adjusting the set weights in an attempt to minimize the difference.

6. The system of claim 5, wherein the processor is further configured to train the neural network based on the input file sizes and at least one of logical record length and block size of the input files, record format, timing of job execution, parameters passed to the program from the input files, names data definitions (DDs) for the input files, and duration of job execution.

7. The system of claim 1, wherein the processor is further configured to extract the history file from systems management farcicalities (SMF) records indicating job related information.

8. The system of claim 1, wherein the one or more sequential input files and sequential output files contain transactional data for the customer, and the one or more records contain information about a transactional event.

9. The system of claim 1, wherein the customer program used during processing of the past sequential input files of the historical data is the same as the customer program used during processing of future sequential input files.

10. The system of claim 1, wherein the processor is further configured to use at least one of the predicted future sizes of future sequential output files, CPU time, and memory consumption to determine at least one of memory allocation for storing the sequential output files and processing time for producing the sequential output files.

11. A method used in predicting resources required for a program, the method comprising:
accessing, by a processor, a history file to determine sizes of past sequential input files of one or more sequential input files input to a customer program and sizes of resultant past sequential output files produced by the customer program processing the sequential input files;
determining, by the processor, a correlation between the sizes of the past sequential input files and the resultant sizes of the past sequential output files;
utilizing, by the processor, the correlation to predict future consumption of the scalable resources including future sizes of future sequential output files based on the current sizes of current sequential input files; and
utilizing, by the processor, the predicted future consumption of the scalable resources to perform at least one of memory allocation or to determine scheduling for batch jobs to be performed by a system,
wherein the scalable resources include at least one of processing time, working memory or input/output time.

12. The method of claim 11, further comprising:
determining, by the processor, the correlation by performing a linear regression on the sizes of the past sequential input files and the resultant consumption of scalable resources, the linear regression producing a linear function for performing the prediction of the future consumption of the scalable resources based on the current sizes of the current sequential input files of the one or more sequential input files.

13. The method of claim 12, further comprising:
performing, by the processor, the linear regression as N×M linear regressions for N×M combinations of N input files by M output files, where N and M are integer values ranging between 1 and a maximum number of input files and output files that is supported by the program.

14. The method of claim 12, further comprising:
performing, by the processor, the linear regression K×N linear regressions for N input files and K transformations for each of the scalable resources consumed, where N is an integer value ranging from 1 to a number of indicating each input file data definition (DD).

15. The method of claim 11, further comprising:
determining, by the processor, the correlation by training a neural network by inputting the sizes of the past sequential input files, processing the sizes of the past sequential input files based on set weights, predicting resource consumption of the scalable resources, computing a difference between the predicted resource consumption and the known resultant consumption of past scalable resources, and adjusting the set weights in an attempt to minimize the difference.

16. The method of claim 15, further comprising:
training, by the processor, the neural network based on the input file sizes and at least one of logical record length and block size of the input files, record format, timing of job execution, parameters passed to the program from the input files, names data definitions (DDs) for the input files, and duration of job execution.

17. The method of claim 11, further comprising:
extracting, by the processor, the history file from systems management farcicalities (SMF) records indicating job related information.

18. The method of claim 11, wherein the one or more sequential input files and sequential output files contain transactional data for the customer, and the one or more records contain information about a transactional event.

19. The method of claim 1, wherein the customer program used during processing of the past sequential input files of the historical data is the same as the customer program used during processing of the future sequential input files.

20. The method of claim 11, further comprising:
using, by the processor, at least one of the predicted future sizes of future sequential output files, CPU time, and memory consumption to determine at least one of memory allocation Page 9 for storing the sequential output files and processing time for producing the sequential output files.

21. The system of claim 1, wherein determining the scheduling for batch jobs includes rescheduling a batch job of the batch jobs for a later time when system load of the system is lower based on a prediction of the processing resources necessary to execute the batch job.
